(19) United States
(12) Patent Application Publication
(10) Pub. No.: US 2016/0356406 A1
(43) Pub. Date: Dec. 8, 2016

(54) HYBRID SOLAR MODULE COUPLING AND METHOD OF MAKING

(71) Applicant: Sharp Kabushiki Kaisha, Osaka (JP)

(72) Inventors: Colin BURGESS, Wirral (GB); Jacob BARRETT, Chester (GB); Michael Charles TOMLIN, Abingdon (GB)

(21) Appl. No.: 14/733,055

(22) Filed: Jun. 8, 2015

(51) Int. Cl. F16L 13/02; F16L 19/00; B23P 19/00

(52) U.S. Cl. CPC F16L 13/0245; B23P 19/00; F16L 19/00

(57) ABSTRACT

A fluid coupler for hydronic solar panels, framed with a rigid frame that, when engaged includes a male coupling rigidly attached to a first manifold pipe. The male coupling has a sealing face perpendicular to a longitudinal axis of the first manifold pipe. The coupler includes a female coupling rigidly attached to a second manifold pipe. The female coupling has a sealing face perpendicular to a longitudinal axis of the second manifold pipe and includes a coupling nut longitudinally constrained along and freely rotatable around the axis of the second manifold pipe.

### TECHNICAL FIELD & BACKGROUND

The invention relates to the conveyance of a fluid through a hybrid solar module. In particular, the invention relates to a coupling mechanism allowing hydronic connection between hybrid solar modules.

Hybrid, or PV-T solar modules are a combination of photovoltaic (PV) and thermal modules, designed primarily to increase the energy yield from solar modules. The basic concept of utilising the waste heat from solar PV modules has been known in the prior art for some decades, though several issues exist that prevent mass uptake of the solutions. Due to the relative low yield of PV, and to maximise the economics of installation costs, it is common to install as large a PV array as the installation site will allow. For this reason a high packing fraction of modules is desirable, to allow for maximum utilisation of the available space. Photovoltaic modules are commonly designed as a flat laminate, comprising a glass front for structural support and to act as a barrier layer; crystalline silicon solar cells encapsulated in an elastic polymer; and a layered plastic polymer backing film. To keep the laminate supported and rigid in situ, PV modules are often framed. This is commonly with an extruded aluminium profile, chosen for its high strength to weight ratio and weatherability.

Heat can be extracted from PV-T modules via the circulation of a working fluid, which may be liquid or gaseous. There is an inherent antagonistic relationship that exists with PV-T modules: the higher the extracted fluid temperature, the more useful the fluid is, however the efficiency of silicon PV cells decreases with higher temperatures. To this end the fluid system circulating in the PV-T modules should be as close to the PV laminate temperature as possible.

Domestic installations of solar modules are almost exclusively on rooftops, to maximise use of available space as well as to ensure maximum exposure to the sun.

Because installation of PV-T modules will generally be on a rooftop, minimising the complexity of work to be done on-site is of great benefit. To this end some designs of PV-T module incorporate a fluid manifold as part of the construction of the module. This means that the fluid distribution work is minimised for the installer; only a feed and return line to the modules needs to be fitted, rather than having to construct a separate manifold to parallelize the fluid flow.

Pumping pressure loss is of consideration with regards to PV-T modules. The large combined fluid flow distance due to a potentially large number of modules, combined with the viscosity of circulating fluids and desire for small channels to minimize overall weight and fluid volume, mean that pressure losses can be significant through the module array. This means that ensuring maximum cumulative flow cross section at all points within the fluid circuit is important.

### BACKGROUND ART

The prior art details general fluid couplings as well as fluid couplings specifically for hybrid PV-T module and solar thermal modules.

U.S. Pat. No. 938,425A (Kelly, published Oct. 26, 1909) describes a detachable 3 part pipe union with a coupling nut that engages with a male coupling component, and a cup-shaped washer that seals the two faces of the union, giving a water tight coupling.

U.S. Pat. No. 1,043,294A (Brinkop, published Nov. 5, 1912) describes a swivel union, with a male component, a female component and a coupling nut. The female component can freely rotate in the engaged coupling.

TW201416595A (Imamura Hitoshi, et al., published May 1, 2014) describes a female member for a polymer coupling with a threaded connection, a cylindrical bore and a flanged male component with threaded nut.

EP1788321A3 (Wolfgang, published Oct. 16, 2013) describes a pressure tight coupling between the end of a header pipe connecting a conduit and a solar collector. The connection has an O-ring provided as a seal, where an end area of the connecting line which is led to a side surface of a solar collector is designed as an angle sleeve. A union nut is fixed on a retaining washer grasped behind an end area of the heat transfer medium collecting pipe for pre-stressing the O-ring in a retainer of the sleeve. The end area of the pipe is designed as a pipe sleeve.

WO2008104561A2 (Bruno, published Nov. 4, 2008) describes a joint for connecting pipes. The female connector has a through-hole for passing through the pipe into an insert. The insert has teeth designed to grip the pipe end, and has a conical face which sits against the face of the female part. The male part also has an insert, which compresses against the female insert to seal.

CA2057952A1 (Frank, et al., published Jun. 25, 1992) describes an arrangement for connecting two parts of a fluid system. The female connection uses a union nut and flanged pipe end to compress an O-ring against a filleted face on the male connector. The male connector is fixed (welded) to a filter.

CN203297766U (Chen Jun, et al., published Nov. 20, 2013) describes a connecting device for flat-plate solar thermal collectors. A header seal ring is arranged between the protruding pipe end of each header. Each pipe has a ring protrusion, which creates a boss in the rubber connecting sleeve. Between the protruding rings and frame, and around the connecting sleeve, sits a clamping hoop. This secures and seals the coupling element in place.

US20100218809A1 (Garth, et al., published Sep. 2, 2010) describes a hybrid module designed to incorporate a means of both thermal energy production and electrical energy production from the solar energy produced by the sun. The enclosure is molded polypropylene and contains a recess to accommodate large couplings

EP2310733B1 (Tomasz, et al., published May 30, 2012) describes a pipe joint for a solar collector, which fastens the connector to the collector wall, and connects through the wall. The connector pipe is polygonal and is seated in the socket of a secondary part, which serves to secure the connector, as well as thermally insulate the pipe

EP2048453A1 (Lawrence, published Apr. 15, 2009) describes a solar panel that has a locating key on the header tube and key way in the side wall to prevent misalignment and twists of the tubing within the panel

Energetyka Solarna Ensol Sp. z o.o. have commercialised a PV-T module with a welded dual entry manifold. The product utilises a planar heat exchanger encased in the frame of a PV module. The fluid connections from the heat exchangers, are welded into a meandering pipe manifold. The pipe manifold passes through the frame of the PV module and terminates in a tubular pipe.

Solarzentrum Allgau have commercialised a solar PV-T module, utilising a push-fit coupling which has teeth-grip connecting piping sections. The push-fit connectors are embedded in an integrated polyurethane frame discussed in WO2007144113A1. The plastic frame has good moldability so the connectors can be recessed. However using plastic will limit the life of a solar module due to UV exposure. The part will also be expensive and needs to be reinforced due to the low strength.

### SUMMARY OF INVENTION

With couplings that are designed specifically for solar modules, these prior-art devices all have limitations in design, such as sub-optimal spacing of modules, concessions in material choice and mechanical design to create closer to optimal spacing, and couplings which require extra components to engage or otherwise complete the connection. Therefore, described herein is a hybrid solar module coupling and method of making the same that improves upon the prior-art.

According to a first embodiment of the invention, a fluid coupler for hydronic solar panels, framed with a rigid frame that, when engaged, has a frame to frame distance of 15-25 mm, includes: a male coupling rigidly attached to a first manifold pipe, the male coupling having a sealing face perpendicular to a longitudinal axis of the first manifold pipe; and a female coupling rigidly attached to a second manifold pipe, the female coupling having a sealing face perpendicular to a longitudinal axis of the second manifold pipe, and wherein the female coupling includes a coupling nut longitudinally constrained along and freely rotatable around the axis of the second manifold pipe.

Optionally, the rigid frame is made from a metal.

Optionally, the male coupling terminates inside a solar panel module with a spigot coupling that is engaged after a frame has been applied to the solar panel module.

Optionally, the engaged configuration creates a distance between the shoulder of the male coupling and the shoulder of the female coupling that is the same width as the internal frame to frame distance, so that the projection of couplings beyond the frame is constant.

Optionally, the female coupling terminates inside a solar panel module with a spigot coupling that is engaged after a frame has been applied to the solar panel module.

Optionally, the spigot is formed by welding or machining.

Optionally, the engaged configuration creates a distance between the shoulder of the male coupling and the shoulder of the female coupling that is the same width as the internal frame to frame distance, so that the projection of couplings beyond the frame is constant.

Optionally, the freely rotating nut is constrained between the frame and an internal shoulder of a flat faced body element of the female coupling.

Optionally, the coupling nut is engaged with the male coupling, a continuous straight pipe through multiple solar panel modules.

Optionally, the coupling nut is engaged with the male coupling forming a continuous pipe, the formed continuous pipe has constant inner diameter to minimize pressure loss.

Optionally, the male coupling and female coupling are made of the same material to avoid corrosion.

Optionally, the frame is predominantly flat walled.

Optionally, the diameter of the male coupling is larger than a clearance hole in the frame.

Optionally, the diameter of the female coupling is larger than a clearance hole in the frame.

Optionally, an O-ring seal is constrained in an annular groove in one of the sealing faces.

Optionally, the annular groove is an angled groove providing positive retention force on the O-ring tending to prevent displacement of the O-ring retained therein.

Optionally, the fluid coupling is in combination with first and second hydronic solar panels, framed with rigid frames that when engaged, have a frame to frame spacing of 15-25 mm, the coupling being disposed in the spacing.

Optionally, the male and female couplings extend through respective clearance holes disposed in respective frame portions of respective solar panel modules, and the respective clearance holes each include an anti-rotation feature tending to prevent rotation of the manifold pipe with respect to the frame portion thereat when torque is applied to the coupling nut.

Optionally, the anti-rotation feature comprises one or more flat edges.

Optionally, the coupling nut is constructed from a polymer.

According to another aspect of the invention, a method of making a hybrid solar panel module includes the steps of: assembling a photovoltaic laminate; connecting a roll bond heat exchanger to the laminate using an adhesive layer; applying a sealing gasket and frame to the module; preassembling coupling and pipe sections to form the spigot for connecting into a central manifold tee; inserting the spigot-coupling sections through an orifice in the coupling nut and clearance holes of the frame; and connecting the manifold to the internal tee connector after the inserting.

To the accomplishment of the foregoing and related ends, the following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 shows a cross section of an exemplary disengaged coupling part, the partially exploded view shows the major part of the complete coupling;

FIG. 2 shows the coupling nut retained between the female coupling body element and the frame of the module;

FIG. 3 shows a cross-section of an exemplary female coupling body element passing though the clearance hole in the frame. The parts are of substantially similar cross-section, such that the female part cannot rotate within the frame;

FIG. 4 shows a plan view of an exemplary fully assembled module, with the fully assembled manifold positioned within the frame of the module, securing all coupling elements in place;

FIGS. 5A-5D show multiple embodiments of the anti-rotation feature; and

FIG. 6 shows an exemplary O-ring groove with detail to retain the O-ring in place.

### DESCRIPTION OF REFERENCE NUMERALS

1 Female coupling
2 Coupling nut
3 Male coupling
4 O-ring
5 Welded joint
6 O-ring groove
7 Sealing face
8 Frame
9 Manifold pipe
10 Frame clearance hole anti-rotation feature
11 Pipe bore
12 Roll-bond heat exchanger
13 Manifold tee coupling
14 Coupling anti-rotation feature
15 Female coupling body element
16 First portion of coupling body element
17 Second portion of coupling body element
18 Shoulder
19 Third portion of coupling body element
20 Shoulder
21 Inner bore

### DETAILED DESCRIPTION OF INVENTION

A coupling mechanism for hybrid photovoltaic-thermal modules and method of making the coupling is described herein. As a non-exhaustive example, preferred embodiments could be used as part of a domestic or commercial solar installation with associated balance of system, particularly for the coupling of hybrid solar modules.

An exemplary PV-T module comprises a PV laminate: a layered structure containing a glass front, EVA (ethylene-vinyl acetate), silicon PV cells, a second EVA layer, and a plastic backing film; a flexible adhesive layer; one or more metal heat exchangers (e.g. copper or aluminium) formed through the roll-bond process; entry and exit pipes protruding from the roll-bond heat exchanger; one or more tee-piece coupling elements that preferably mechanically engage to this pipe; a pair of tubular pipe-manifolds into which the aforementioned mechanical coupling elements engage, which run from the frame of the module to the opposite frame edge; a frame which encloses the PV-T module, with clearance holes through which the manifold pipes can pass through for entry and exit from the module; two or more threaded male coupling elements, which protrude through the frame and have a diameter larger than the clearance hole in the frame; an equal number of female coupling components, which have a sealing face of larger diameter than the clearance hole in the frame; and captured between the frame and each sealing face of female couplings is retained a threaded coupling nut. The male coupling element may have a facial groove, in which sits an O-ring, to hydraulically seal the coupling. The female coupling may have a flat circular face against which to make the hydraulic seal. The female coupling also has a shoulder butting up against the outer face of the frame, serving to retain the manifold in place between the two outer edges of the module frame. Captured between the female coupling part and the frame, sits the retained nut for engaging the coupling with a male component on another module or external piping. The nut is free to rotate about the axis of the manifold, though it is constrained in movement longitudinally, retaining it in place. The restraint of the coupling nut reduces the length of travel required for sufficient engagement of the nut and male coupling part, reducing the overall length of the coupling, without having to provide means outside of the frame to secrete the excess or have a large distance between modules.

To form this arrangement, the hybrid module is assembled firstly as a complete laminate. The roll bond heat exchanger is then connected to the laminate using the adhesive layer. The sealing gasket and frame are then applied to the module. After the module is framed, the coupling and pipe sections have been pre-assembled to form the spigot for connecting into the central manifold tee. The spigot-coupling sections are then inserted through the orifice in the coupling nut and clearance holes in the frame. The manifold connections are made to the internal tee connector, preferably though a cold process (not requiring the use of any welding or brazing, for example). The coupling and clearance holes have compatible non-circular cross-sections, such that the manifold cannot rotate within the clearance hole, preventing damage by twisting of the manifold that may otherwise occur during connection. All of the coupling elements, frame and manifold may be made from the same material (preferably an aluminium alloy), so that the linear coefficient of thermal expansion is very similar and galvanic potential between components is negligible, thus minimising corrosion.

### Advantages of the Invention

The engaged connection can sustain high pressure (≧2.5 bar). The ability to withstand high pressure due to the use of threaded connections means that a large total circuit pressure drop can be accommodated, permitting multiple strings of PV-T module to be connected in series
Controlled spacing allows compatibility with many widely available types of racking clips: Conventional PV racking clamps fit into a gap, between adjacent modules, of approximately 20 mm or greater when engaged. As the invention creates a spacing when engaged of approximately 20 mm, most types of standard PV racking clips can be used
Ease of installation using a single connection. Because there are no detachable parts (All coupling parts can be retained (nut, O-ring) so there is nothing to be lost on roof during installation), so installation time is reduced.
Because the inter-module spacing is minimised by the invention, there is a greater packing fraction of modules, meaning that more modules may be installed on a roof. It also provides a more discrete coupling and improved aesthetics, with a less visible gap between modules
The assembly method allows the connections to be a larger diameter than the clearance hole in the frame, permitting a continuous pipe diameter to be maintained through the manifold without having bare pipe protruding from the frame.
All of the coupling elements, frame, manifold and heat exchanger may be made of the same material (preferably aluminium), this avoids any issues associated with galvanic corrosion.
There is greater mechanical strength in the coupling due to large diameter of the coupling relative to protruding length, meaning the couplings are less likely to be damaged in transportation
If any hot work is needed to fabricate the spigot-coupling sections, it can be carried out away from the panel due to the method of assembly.
The couplings fit through a PV frame of much less than 50 mm depth. Clamping arrangements for PV modules have generally a maximum jaw opening of <50 mm, meaning that the invention can be used with conventional PV racking systems

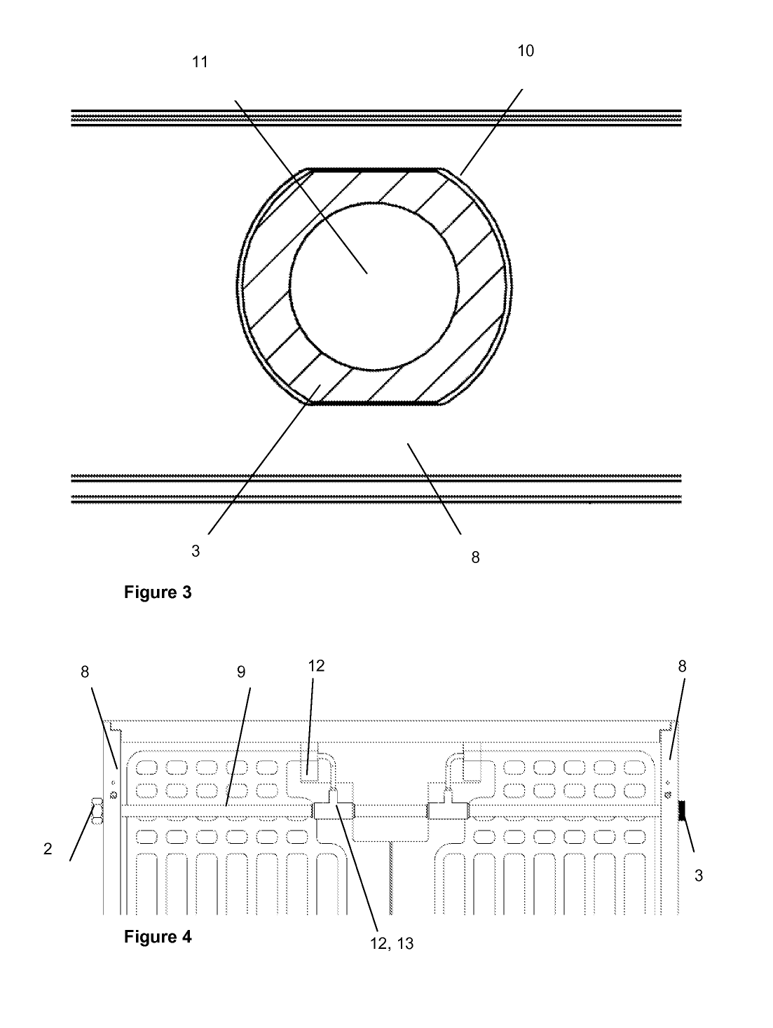

As shown in FIG. 4, the hybrid module utilises a minimum of one heat exchanger 12 to extract waste heat from the conversion of light absorbed by the photovoltaic cells, as well as thermal energy from surrounding air. The heat exchanger 12 may be substantially planar on one side so as to sit flush with the back surface of the PV laminate. The heat exchanger 12 may be made from metal (preferably copper or aluminium) to provide high thermal conductivity.

The heat exchanger 12 is connected to a laminate comprising glass front, EVA, silicon PV cells, a second EVA layer, and a plastic backing film. An adhesive layer, in one embodiment made of a foam acrylic tape, attaches the planar heat exchangers 12 to the plastic backing film of the laminate.

A rubber gasket is applied to the perimeter of the laminate to prevent water ingress. Frame 8 sections are then applied to the edges of the laminate for support, and secured, for example, using screws.

As shown in detail in FIG. 3, two opposite edges of the frame 8 contain non-circular clearance holes 10 for manifold pipes 9 to pass through and also to mate with the couplings and prevent axial rotation.

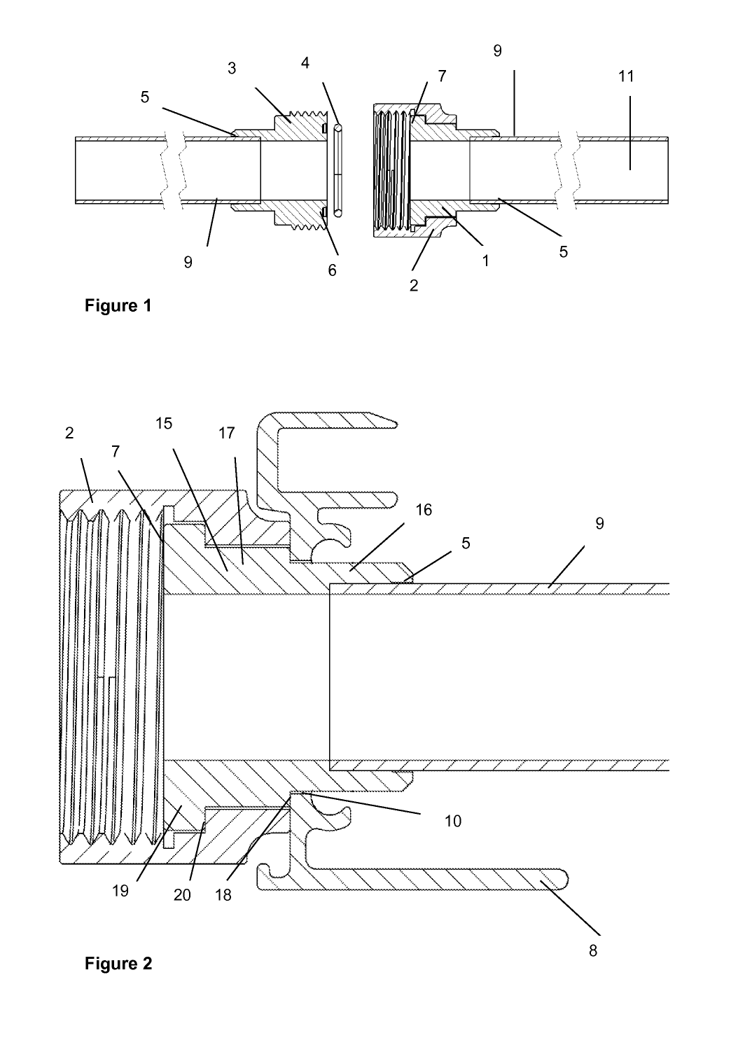

As shown in FIGS. 1 and 2, tubular metal pipe sections form a flow distribution manifold 9. One female 1 and one male pipe coupling 3, pre-attached to (for example, welded onto) a manifold pipe section 5 are passed through opposite the clearance holes 10 in the frame 8.

The male 3 and female coupling 1 connection each includes a sealing face perpendicular to the axis of the pipe manifold. The female coupling 1 includes a coupling nut through which the rest of the coupling 1 is first passed through before being passed through the frame 8.

These pipe sections are then secured and locked in place with a mechanical connection, such that the distance from each frame 8 outer edge matches the distance between outwards facing male 3 and female couplings 1. This prevents both the couplings and frame 8 from moving, and locks in place the coupling nut 2, preventing it from moving substantially longitudinally, but allowing free rotation about the manifold pipe 9 axis.

As shown in detail in FIG. 2, the female coupling 1 includes a coupling body 15 around which the nut rotates. The body 15 includes a stepped design having a first (proximal) portion 16 extending through the opening 10 of the frame and which includes any anti-rotation features.

Immediately adjacent the first portion 16 is a second (middle) portion 17 with a greater outer diameter than the first portion 16 forming a shoulder 18 which prevents the body 15 from entering the frame any farther.

Immediately adjacent the second portion is a third (distal) portion 19 with a greater outer diameter than the second portion 17 forming a shoulder 20 against which the nut urges the female coupling 1 against the male coupling 3 when engaged with the male coupling 3.

The inner bore 21 includes a stepped counter bore into which the manifold pipe 9 is fitted. The inner diameter of the bore is preferably the same as the inner diameter of the manifold pipe.

All of the coupling elements, frame and manifold may be made from the same material (preferably an aluminium alloy), so that the linear coefficient of thermal expansion is very similar and galvanic potential between components is negligible, thus minimising corrosion.

In another embodiment, the coupling nut 2 is constructed from a polymer.

The heat exchanger 12 has a welded or otherwise secured pipe section, which is also fixed into the tee coupling 13 of the manifold pipe 9. The fluid enters and exits the heat exchanger 12 using these pipes that have been welded into the channel structure of the roll bond.

Preferably, the bore 11 of the male 3 and female couplings 1 and manifold pipe 9 is the same or similar, such that there is no restriction of flow upon exit or entry to the couplings. In particular, the inner diameter of the couplings 1, 3 is equal to the inner diameter of the manifold pipe 9.

The O-ring 4, providing the hydraulic seal against the face 7 of the female coupling 1, is preferably sat within an angled circular groove 6 of the male coupling 3, such that it is retained in place, preventing the O-ring 4 from easily being displaced.

In another embodiment, the seal 4 between male 3 and female couplings 1 is a fibre washer disposed between the end faces of the male 3 and female couplings 1.

As shown in FIG. 4, in an embodiment, the male 3 and female coupling 1 elements are constructed with spigot end sections. These are similarly assembled after the frame 8 has been applied, and pass through the clearance holes 10 to create the manifold 9, but are engaged directly into the manifold 9, without the need for separately securing a pipe section by welding or a similar process into the coupling. 5 The couplings 1, 3 and pipe sections may be pre-assembled to form the spigot for connecting into the central manifold tee 13. After the solar panel module is framed, the spigot-coupling sections are then inserted through the orifice in the coupling nut and clearance holes. The manifold connections are made to the internal tee connector 13, preferably through a cold process (not requiring the use of any welding or brazing, for example).

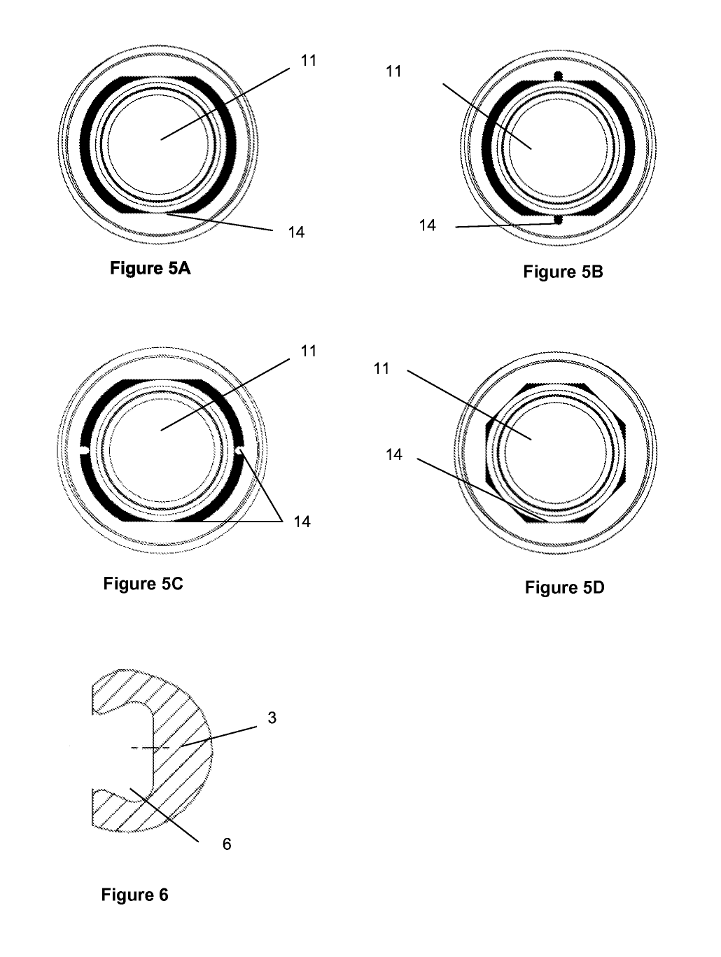

In other embodiments, for example, those shown in FIGS. 5A-5D, the anti-rotation feature 14 of the male 3 and female couplings 1 and the frame 10 8 have features to improve the mechanical resistance to rotation. The anti-rotation feature 10 14 is substantially non-circular, incorporating features to prevent rotation of the manifold 9. These features 10 14 could incorporate a number of flat sections and/or key sections for alignment. The number of flat sections could preferably be 2, 4, 5 or 6. In any case, the male 3 and female couplings 1 would include complimentary features to match those of the openings 10. For example, the opening may include one or more lock notches as shown in the second embodiment of FIG. 5, and the corresponding coupling would include one or more complimentary key nubs to fit in the lock notch(es). Additionally or alternatively, the opening may include one or more key nubs and the corresponding coupling would include corresponding complimentary lock notches.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

1. A fluid coupler for hydronic solar panels, framed with a rigid frame, comprising:
a male coupling rigidly attached to a first manifold pipe, the male coupling having a sealing face perpendicular to a longitudinal axis of the first manifold pipe; and
a female coupling rigidly attached to a second manifold pipe, the female coupling having a sealing face perpendicular to a longitudinal axis of the second manifold pipe, and wherein the female coupling includes a coupling nut longitudinally constrained along and freely rotatable around the axis of the second manifold pipe.

2. The fluid coupler of claim 1, wherein the male coupling terminates inside a solar panel module with a spigot coupling that is engaged after a frame has been applied to the solar panel module.

3. The fluid coupling of claim 2, wherein the spigot is formed by welding or machining.

4. The fluid coupling of claim 2, wherein the engaged configuration creates a distance between the shoulder of the male coupling and the shoulder of the female coupling that is the same width as the internal frame to frame distance, so that the projection of couplings beyond the frame is constant.

5. The fluid coupling of claim 1, wherein the female coupling terminates inside a solar panel module with a spigot coupling that is engaged after a frame has been applied to the solar panel module.

6. The fluid coupling of claim 5, wherein the spigot is formed by welding or machining.

7. The fluid coupling of claim 5, wherein the engaged configuration creates a distance between the shoulder of the male coupling and the shoulder of the female coupling that is the same width as the internal frame to frame distance, so that the projection of couplings beyond the frame is constant.

8. The fluid coupling of claim 1, wherein the freely rotating nut is constrained between the frame and an internal shoulder of a flat faced body element of the female coupling.

9. The fluid coupling of claim 1 forming, when the coupling nut is engaged with the male coupling, a continuous straight pipe through multiple solar panel modules.

10. The fluid coupling of claim 1, wherein, when the coupling nut is engaged with the male coupling forming a continuous pipe, the formed continuous pipe has constant inner diameter to minimize pressure loss.

11. The fluid coupling of claim 1, wherein the male coupling and female coupling are made of the same material to avoid corrosion.

12. The fluid coupling of claim 1, wherein the frame is predominantly flat walled.

13. The fluid coupling of claim 1, wherein the diameter of the male coupling is larger than a clearance hole in the frame.

14. The fluid coupling of claim 1, wherein the diameter of the female coupling is larger than a clearance hole in the frame.

15. The fluid coupling of claim 1 further comprises an O-ring seal constrained in an annular groove in one of the sealing faces.

16. The fluid coupling of claim 15, wherein the annular groove is an angled groove providing positive retention force on the O-ring tending to prevent displacement of the O-ring retained therein.

17. The fluid coupling of claim 1, in combination with first and second hydronic solar panels, framed with rigid frames that when engaged, have a frame to frame spacing of 15-25 mm, the coupling being disposed in the spacing.

18. The fluid coupling of claim 1,
wherein the male and female couplings extend through respective clearance holes disposed in respective frame portions of respective solar panel modules, and
wherein the respective clearance holes each include an anti-rotation feature tending to prevent rotation of the manifold pipe with respect to the frame portion thereat when torque is applied to the coupling nut.

19. The fluid coupling of claim 18, where the anti-rotation feature comprises one or more flat edges.

20. A method of making a hybrid solar panel module, the method comprising the steps of:
assembling a photovoltaic laminate;
connecting a roll bond heat exchanger to the laminate using an adhesive layer; applying a sealing gasket and frame to the module;
preassembling coupling and pipe sections to form the spigot for connecting into a central manifold tee;
inserting the spigot-coupling sections through an orifice in the coupling nut and clearance holes of the frame; and
connecting the manifold to the internal tee connector after the inserting.
